(19) United States
(12) Patent Application Publication
(10) Pub. No.: US 2024/0060563 A1
(43) Pub. Date: Feb. 22, 2024

(54) GEARBOX ACTUATOR UNIT AND GEARBOX

(71) Applicant: ZF Friedrichshafen AG, Friedrichshafen (DE)

(72) Inventor: Stephan HAHN, Bundorf (DE)

(21) Appl. No.: 18/233,453

(22) Filed: Aug. 14, 2023

(30) Foreign Application Priority Data
Aug. 16, 2022 (DE) 102022208484.5

(51) Int. Cl. F16H 63/04; F16H 63/30; F16H 63/32

(52) U.S. Cl. CPC F16H 63/04; F16H 63/304; F16H 63/32; F16H 2057/02026

(57) ABSTRACT

A gearbox actuator unit (12) is formed so as to be to be arranged on a gearbox (10). The unit (12) has a flange (14), an actuator (16, 18), a rack (20, 22) and a guide (24, 26). The flange (14) is formed to be connectable to a housing of the gearbox. The rack (20, 22) is received in an axially moveable manner within the guide (24, 26). The actuator (16, 18) meshes with the rack (20, 22) via a pinion (44, 46) and is formed so as to move the rack (20, 22) axially.

### BACKGROUND OF THE INVENTION

### 1. Field of the Invention

The invention relates to a gearbox actuator unit and to a gearbox comprising a gearbox actuator unit of this type.

### 2. Description of the Related Art

In the prior art, gearboxes which are shifted by electric actuators are known. An electric actuator of this type, which comprises an electric motor, provides a rotational movement, which in turn is converted into a linear movement of a shift fork. The linear movement of the shift fork shifts a gear of the gearbox.

### SUMMARY OF THE INVENTION

An object of the invention is to provide a gearbox and a gearbox actuator unit which has a compact construction, a long service life and makes it possible to achieve simple, rapid installation.

A gearbox actuator unit of this type, which is formed so as to be arranged on a gearbox, comprises
a flange, an actuator, a rack and a guide,
wherein the flange is formed so as to be connectable to a housing of the gearbox,
wherein the rack is received in an axially moveable manner within the guide,
wherein the actuator meshes with the rack via a pinion and is formed so as to move the rack axially.

In particular, a gearbox and gearbox actuator unit of this type are provided for use in a commercial motor vehicle, in particular a truck.

On the one hand, the flange acts to attach the gearbox actuator unit to the housing. On the other hand, the further components of the gearbox actuator unit are arranged on, attached to, or are formed in one piece with the flange. In this case, the flange separates an interior of the gearbox from an environment so that the gearbox is tightly closed with the aid of the flange. The flange thus makes it possible to arrange components outside the interior so that they are protected from a lubricant in the gearbox, and simultaneously to engage these components in a targeted manner in the interior through the flange. The flange is advantageously formed in one or more pieces. The actuator provides mechanical movement suitable for shifting gears in the gearbox. In particular, the actuator comprises an electric motor and a pinion. The electric motor is advantageously formed as a BLDC motor, brushless DC motor or brushless direct-current motor. The housing provides a protected receiving chamber for components of the gearbox actuator unit. The rack is connected to the actuator, in particular via a pinion, so that the rotational movement of the actuator is transformed into a rectilinear movement. The guide acts to receive and arrange the rack. In this case, the guide restricts the degree of freedom of mobility of the rack to a movement in the axial direction and guides the movement of the rack accordingly. The guide is advantageously formed by one or more components or formed in one piece with another component, for example the flange.

The flange and gearbox are advantageously connected via attachment means, for example screws.

A configuration of this type of the gearbox actuator unit makes it possible to achieve a high degree of pre-assembly, so that the gearbox actuator unit can be rapidly and simply installed on a gearbox as a pre-assembly unit or pre-assembled module.

Advantageous configuration variants of the gearbox actuator unit are described in the explanations below.

In an advantageous configuration variant, the gearbox actuator unit is formed as a pre-assembly unit.

A pre-assembly unit of this type, often also referred to as a module, is characterized in that the components of the pre-assembly unit are arranged and attached to one another, wherein the pre-assembly unit is inserted in its entirety into a higher-level assembly and is attached to the higher-level assembly via an interface. The components of the gearbox actuator unit and the components of the gearbox are formed to engage with, but not attach to, one another once the pre-assembly unit has been installed. For example, this engagement is limited to mutual support or contact.

It is proposed that the gearbox actuator unit can be attached to the gearbox solely via the flange.

This ensures that the gearbox actuator unit can be arranged on and attached to the gearbox in a particularly simple manner. This ensures simple installation and attachment by means of a pre-assembled gearbox actuator unit.

Particularly advantageously, the components of the gearbox actuator unit are connected solely to the flange and, when in contact with components of the gearbox, only mesh therewith.

Accordingly, the gearbox actuator unit is attached to the gearbox solely via the flange. The components of the gearbox actuator unit comprise the actuator, the rack and the guide. Optionally, the components of the gearbox actuator unit also comprise a shift element, in particular a shift fork or shift claw. Components of the gearbox actuator unit, such as a rack or shift element, are arranged on components of the gearbox only via releasable engagement, for example form-fitting engagement, but not via attachment means, such as a force-fitting connection, screw connection, weld joint, etc. Engagement between components of the gearbox actuator unit and components of the gearbox in the form of meshing naturally only applies within this meaning for components of the gearbox actuator unit which actually mesh with components of the gearbox. Engagement of this type is characterized for example by mutual contact or mutual support. Engagement makes it possible, inter alia, to transfer forces between the components.

It is proposed that a shift element is formed on, arranged on or attached to the rack.

The shift element acts to transfer the movement of the rack to a shift sleeve. Movement is transferred directly or indirectly via an intermediate component. A shift element formed on the rack is formed in one piece with the rack. A shift element arranged on the rack is connected to the rack in a captive and axially fixed manner, for example connected in a form-fitting manner. A shift element attached to the rack is securely connected to the rack, for example connected in a force-fitting manner or screwed.

Advantageously, the shift element is formed by a shift fork, a shift claw or a shift contour.

A shift fork engages in a shift sleeve, which connects an idler gear to a gear shaft in a rotationally engaged manner. A shift claw provides a connection between the shift fork and the rack. A shift claw of this type is formed, for example, as a separate component or in one piece with the rack. A shift contour provides a shape which cooperates with a transfer contour. The shift contour and the transfer contour engage with one another to transfer the movement of the rack to the shift fork. The shift contour is formed on the gearbox actuator unit and the transfer contour is formed on the gearbox or shift sleeve. Preferably, the shift contour and the transfer contour engage with one another in a form-fitting manner and for power transmission. The transfer contour is formed, for example, by the shift fork or a transfer element which takes the form of a separate component. A transfer element is formed on the gearbox or on the shift sleeve and engages with a component of the gearbox actuator unit. In contrast, a shift element is formed on the gearbox actuator unit and engages with a component of the gearbox.

It is proposed that the actuator has a pinion which passes through an opening in the flange and extends from the flange.

The pinion extends into the interior of the gearbox in order to cooperate with the rack, which is also arranged in the interior of the gearbox.

Advantageously, the opening in the flange is sealed so as to be fluid tight.

This provides a fluid-tight seal for the gearbox. This also ensures the actuator is sealed relative to the interior of the gearbox. The actuator is thus arranged substantially outside the interior and is not exposed to the lubricant in the gearbox. The seal preferably comprises a radial shaft seal.

It is proposed that the gearbox actuator unit comprises one, two, three or more actuators.

This allows the gearbox actuator unit to be optimally adapted to the configuration of the gearbox. In addition, the arrangement of two, three or more actuators ensures a high degree of pre-assembly in the form of a pre-assembly unit and ensures that a plurality of actuators can be installed rapidly and simply.

Particularly advantageously, the flange has a planar and peripherally closed contact face for making contact with the housing.

In this way, the gearbox can be closed so as to be fluid tight, with an actuator engaged in the interior, in a particularly simple manner. Advantageously, the housing has a corresponding contact face. This contact face of the housing is favorably formed on an end face of a wall of the gearbox. This allows a reliable seal to be provided even if the gearbox housing is a complex shape. A contact face of this type of the flange is formed, for example, by a peripheral and self-contained surface. The corresponding contact face of the gearbox is preferably formed so as to be identical. The contact faces are advantageously sealed by direct or indirect contact. Indirect contact is achieved via an intermediate sealing element, for example a gasket or a molded sealing ring.

It is further proposed to form the guide by means of the actuator, the flange or as a separate assembly.

In a configuration involving the actuator, the guide is formed for example by a housing component of the actuator. In a configuration involving the flange, the guide is formed for example in one piece with the flange. In a configuration involving a separate assembly, the guide is formed by one or more guide elements which collectively provide a guide for the rack. An assembly of this type is, for example, attached to the flange or an actuator. The guide is formed for example in one or more pieces. Consequently, the configuration can be optimally adapted to the installation space available.

The above object is further achieved by a gearbox as claimed in claim 10.

This gearbox comprises a gearbox actuator unit according to at least one of the above embodiments or as claimed in any one of claims 1 to 9.

The gearbox actuator unit is advantageously arranged at the top of or laterally on the gearbox.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The gearbox actuator unit and the gearbox are described in detail below by way of example and with reference to a plurality of figures, in which:

FIGS. 1-4 show a first embodiment variant of a gearbox actuator unit.

FIGS. 5-7 show a second embodiment variant of a gearbox actuator unit.

FIGS. 8-9 show a third embodiment variant of a gearbox actuator unit.

FIGS. 10-12 show a fourth embodiment variant of a gearbox actuator unit.

FIG. 13 shows a fifth embodiment variant of a gearbox actuator unit.

### DETAILED DESCRIPTION OF THE PRESENTLY PREFERRED EMBODIMENTS

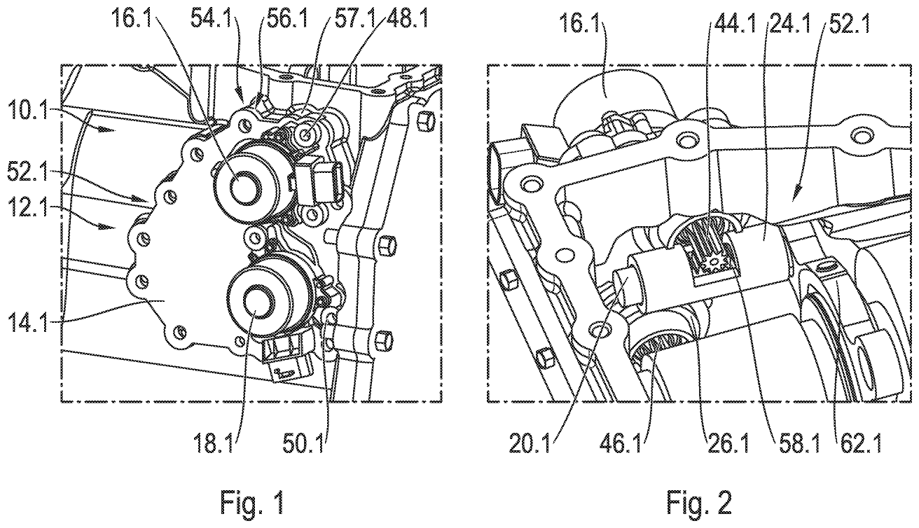

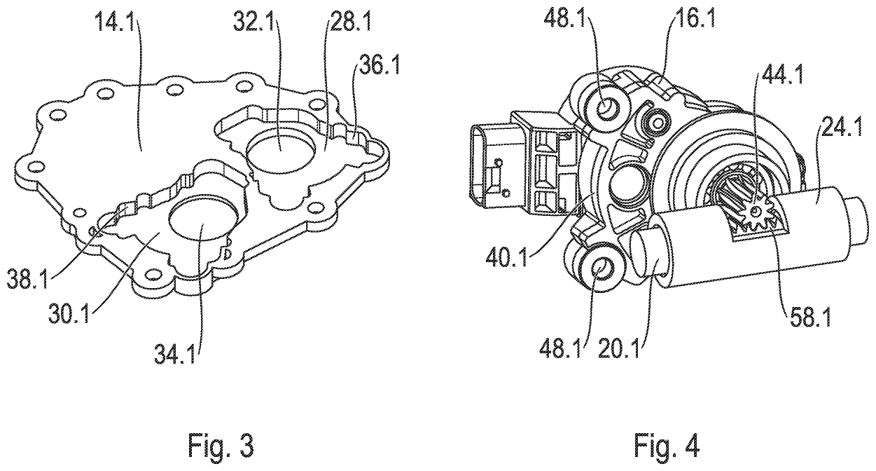

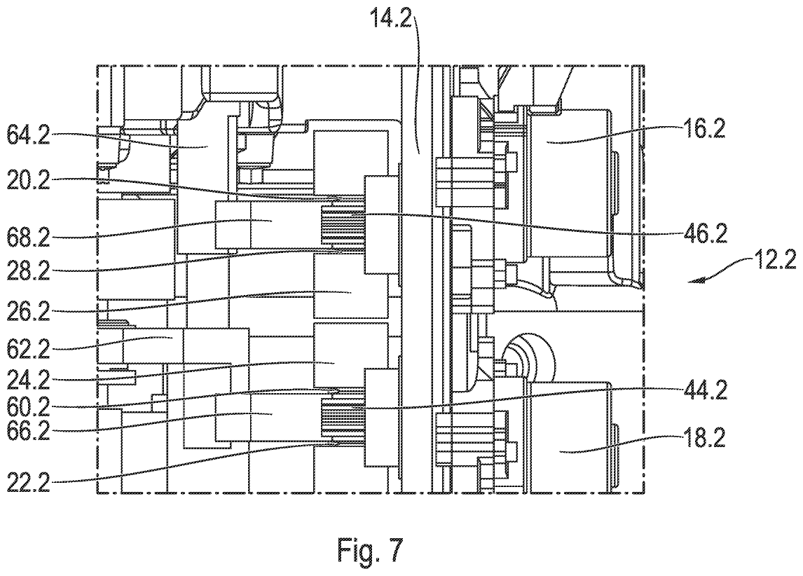

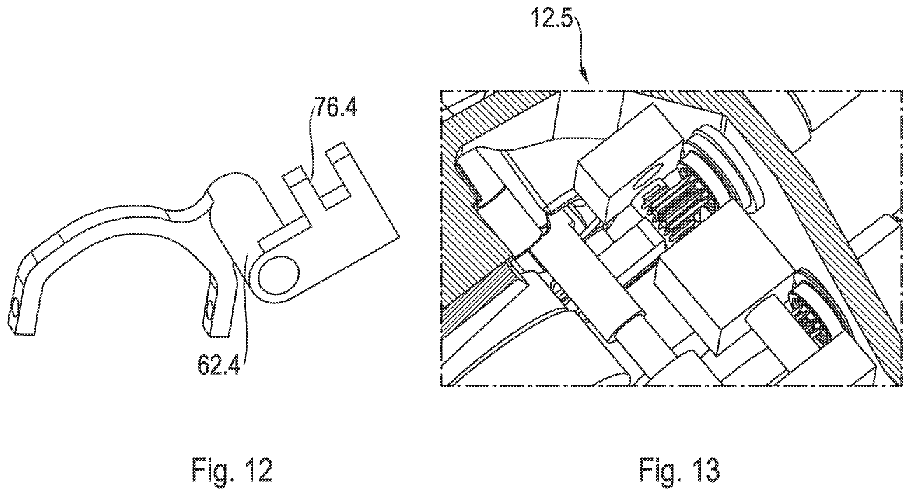

FIGS. 1 to 14 show various embodiment variants of a gearbox actuator unit. The reference signs are used consistently for all examples, with an appended number .1 to .5. The explanations relating to a component in one exemplary embodiment apply analogously to the other exemplary embodiments.

FIGS. 1-4 show a gearbox 10.1 comprising a gearbox actuator unit 12.1. The gearbox is provided for application in a commercial motor vehicle, in particular a truck. The gearbox actuator unit 12.1 is formed to shift the gears of the gearbox 10.1.

The gearbox actuator unit 12.1 comprises a flange 14.1, a first actuator 16.1, a second actuator 18.1, a first rack 20.1, a second rack 22.1, a first guide 24.1 and a second guide 26.1.

The flange 14.1 is formed by a plate. The plate has a planar surface. A depression 28.1 is formed on the plate for receiving the actuator 16.1, wherein an opening 32.1 is formed within the depression 28.1. The depression 28.1 acts to receive an actuator 16.1. The depression has a peripheral contour 36.1 which corresponds to the contour 40.1 of the actuator 16.1. This ensures a compact arrangement and also unambiguous positioning of the actuator 16.1 on the flange 14.1. A depression of this type on the flange 14.1 can be formed as a cavity or an indentation. A cavity involves the removal of material from the flange 14.1. In an indentation, the contour is pushed through, in full or in part, so that the contour rises from the flange 14.1 on the opposing side of the cavity. An indentation makes it possible to achieve even greater engagement in the flange 14.1. The opening 32.1 enables the actuator 16.1 to pass through the flange 14.1. Consequently, the actuator 16.1 is arranged outside an interior of the gearbox 10.1, wherein the actuator 16.1 simultaneously engages in the interior of the gearbox 10.1. In particular, a pinion 44.1 of the actuator 16.1 engages in the interior of the gearbox 10.1. The actuator 16.1 is sealed relative to the flange 14.1. Sealing is achieved, inter alia, by a radial shaft seal.

Also formed on the flange 14.1 is a second depression 30.1 with a second contour 38.1, the depression acting to receive the second actuator 18.1 with a corresponding contour 42.1. The pinion 46.1 of the second actuator 18.1 passes through the opening 34.1. The explanations of the preceding paragraph also apply accordingly to the second depression 28.1 and the second actuator 18.1.

As shown in FIGS. 1 and 4, the actuators 16.1 and 18.1 have openings 48.1 and 50.1. These openings allow attachment means (not shown), for example screws, to pass through. The actuators 16.1 and 18.1 are attached to the flange with the aid of the attachment means. An attachment means of this type can simultaneously pass through an opening in an actuator and a corresponding opening in the flange, so that the actuator is thus attached to the flange and the flange is therefore also attached to the gearbox 10.1.

The flange 14.1 closes a through-opening 52.1 in a housing of the gearbox. The through-opening 52.1 acts to receive the flange 14.1 and to engage the gearbox actuator unit 12.1 in the interior of the housing 10.1. The flange 14.1 has a contact face 54.1 which faces the gearbox 10.1. The contact face 54.1 is formed to make contact with a contact face 56.1 of the through-opening 52.1. The contact face 56.1 is formed on an end face of a wall 57.1 extending away from the housing. The wall 57.1 makes it possible to configure a planar surface on the housing of the gearbox 10.1 in a simple manner. The gearbox actuator 12.1 is arranged laterally on the housing.

The contact faces 54.1 and 56.1 are formed by peripheral, self-contained surfaces which follow the contour of the flange 14.1 and the through-opening 52.1. The contact faces 54.1 and 56.1 form a seal between the interior of the gearbox 10.1 and the environment. Contact is direct or indirect. Indirect contact is achieved via an intermediate sealing element, for example a gasket or a molded sealing ring.

The racks 20.1 and 22.1 are formed by cylindrical bars, each of which has teeth 58.1 and 60.1 in the central region thereof. The teeth 58.1 and 60.1 correspond to the pinions 44.1 and 46.1 of the actuators 16.1 and 18.1. A rotational movement of an electric motor of the actuator 16.1, 18.1 brings about a rotational movement of the pinion 44.1, 46.1, which is converted into a linear movement via the engagement of the pinion 44.1, 46.1 with the respective rack 20.1, 22.1.

The racks 20.1 and 22.1 are arranged in guides 24.1 and 26.1, which limit the mobility of the racks 20.1 and 22.1 to a linear movement. The guide 24.1 and 26.1 is attached to the actuator and/or the flange 14.1. The guides 24.1 and 26.1 have a cylindrical receiving chamber for receiving the cylindrical racks 20.1 and 22.1. This receiving chamber is recessed in regions for engaging the pinion 44.1, 46.1 with the respective rack 20.1, 22.1. The racks 20.1, 22.1 extend in an axial direction beyond the receiving chamber of the respective guide 24.1, 26.1 thereof. A shift fork 62.1 or 64.1 is formed on or attached or connected to an axial end region of the rack 20.1, 22.1. A shift fork is formed on a rack, for example, by configuring it in one piece therewith. It is attached, for example, by a screw connection or an interference fit between the rack and the shift fork. It is connected, for example, by engaging a shift contour on the rack in a form-fitting manner with a transfer contour on the shift fork.

The shift fork is formed so as to engage in a shift sleeve. In this case, the shift sleeve is arranged on a gear shaft in an axially displaceable manner. To shift gears, the shift sleeve is axially displaced on the gear shaft so that an idler gear is securely connected to the gear shaft. A rotational movement of the pinion is translated into a linear movement via the rack, wherein the linear movement for shifting gears is transferred to the shift fork by a shift sleeve. The guide is formed in such a way that the rack and shift fork can move freely in an axial manner to ensure that the shift sleeve has the axial space required for movement.

An electric motor of an actuator is preferably a BLDC motor, brushless DC motor or brushless direct-current motor. The electric motor is advantageously connected to the pinion via a transmission, in particular a gear transmission. This ensures the shift fork is activated precisely and rapidly. A transmission ratio preferably has a value >1, so that a full rotation of a rotor of the electric motor is translated into a partial rotation of the pinion.

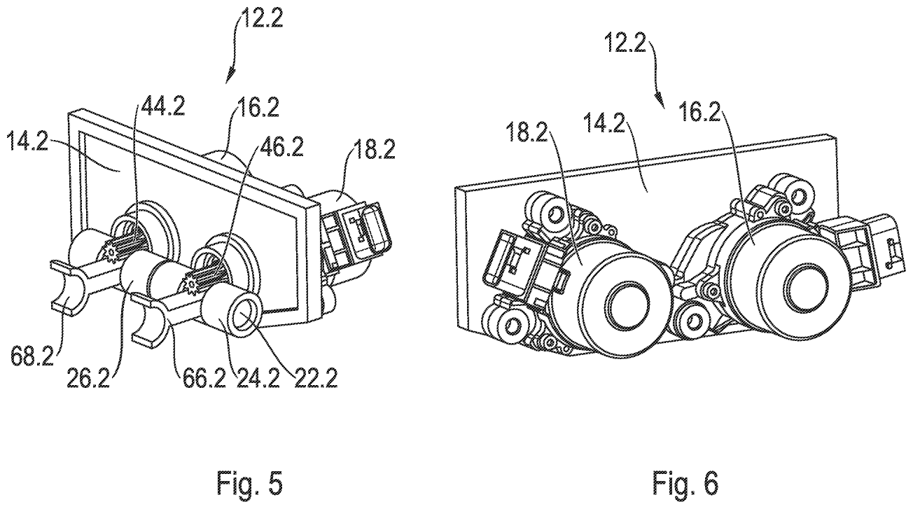

A further embodiment variant of a gearbox actuator unit 12.2 is shown in FIGS. 5 to 7. The differences from the gearbox actuator unit 12.1 are explained in detail below. FIGS. 5 to 7 are simplified views; in particular, appropriate openings for attachment means, which act to attach the flange to the gearbox, are not shown.

The flange 14.2 forms the guides 24.2 and 26.2 in a one-piece configuration. The guides 24.2 and 26.2 are thus not formed by a separate component. For example, the flange 14.2 is produced from die-cast aluminum. Advantageously, the flange 14.2 is produced in a die casting process. The guides 24.2 and 26.2 are formed so as to be hollow cylinders and receive the cylindrical racks 20.2 and 22.2 within them. In order to engage the pinions 44.2 and 46.2, the guides 24.2 and 26.2 are each recessed or interrupted in part in a central area. The recess also provides installation space for the shift claws 66.2 and 68.2. The shift claws 66.2 and 68.2 are connected in an axially fixed manner to the respective rack 20.2 and 22.2, so that a pair, formed from a rack and a shift claw, move together axially. The shift claws are formed to transfer the axial movement of the associated rack to the respective shift fork 62.2, 64.2. A shift claw is correspondingly connected in an axially fixed manner to the respective shift fork. When fitted, a connection is made between the shift claws 66.2, 68.2 and the shift forks 62.2, 64.2. The interruption in the guide provides sufficient axial clearance to ensure that the shift sleeve has the axial space required for movement. The racks 20.2 and 22.2 are guided at the respective axial end regions thereof by the guides 24.2 and 26.2.

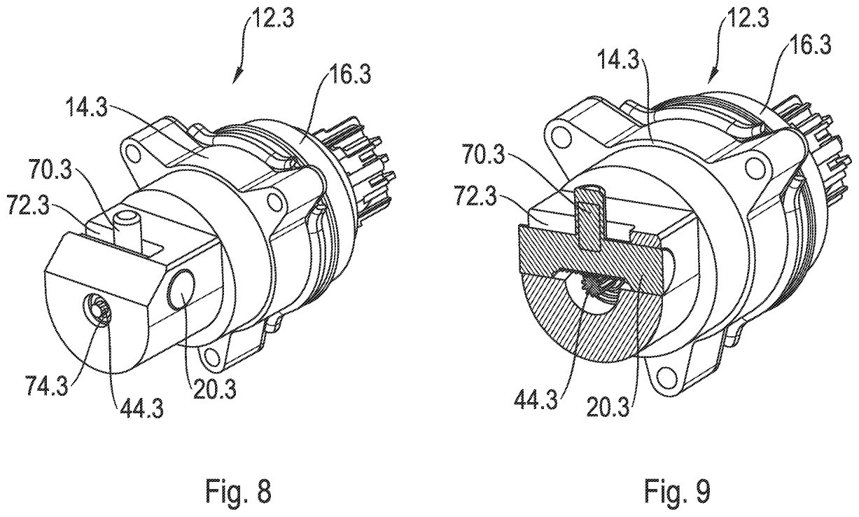

A further gearbox actuator unit 12.3 is shown in FIGS. 8 and 9. The gearbox actuator unit 12.3 has a particularly compact design. The former comprises a compact flange 14.3 for a single actuator 16.3. The flange 14.3 also forms the guide 24.3 in a one-piece configuration, the guide receiving the rack 20.3. The rack 20.3 forms a shift contour 70.3, which extends in the form of a pin from the cylindrical base body of the rack 20.3 orthogonally to the base body. The shift contour 70.3 is guided within a guide contour 72.3 of the flange 14.3, so that the shift contour moves axially together with the base body of the rack 20.3. The guide contour 72.3 prevents distortion of the shift contour 70.3. The shift contour 70.3 is formed to cooperate with the shift fork and to transfer an axial movement to the shift fork. This is achieved, for example, directly or indirectly via a transfer element. For example, a shift claw or a transfer contour, which engages with the shift contour, is formed on the shift fork. The gearbox actuator unit and shift fork are connected when the gearbox actuator unit 12.3 is fitted. As shown in FIG. 8, the pinion 44.3 is mounted, at the axial end region thereof, on the flange 14.3 via a bearing element 74, for example a ball bearing. This reduces deflection of the pinion and load on the actuator 16.3 due to the forces generated.

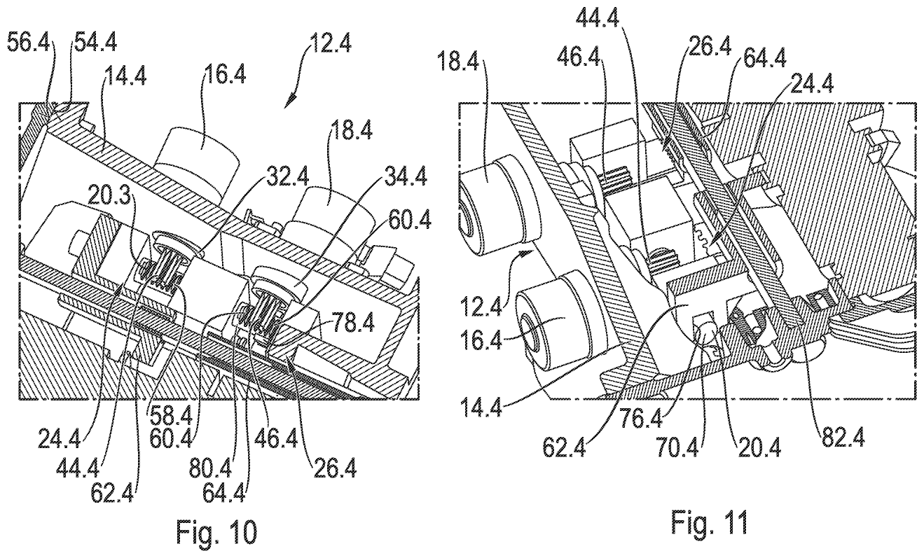

In FIGS. 10 to 12, a further embodiment variant with the gearbox actuator unit 12.4 is shown. The gearbox actuator unit 12.4 is arranged laterally on the housing of the gearbox. The flange 14.4 is in this case L-shaped so that it can be screwed to the gearbox both perpendicularly and parallel to a gearbox axis. The contact faces 54.4 and 56.4 follow the L-shape accordingly, thereby providing a fluid-tight attachment between the gearbox actuator unit 12 and the housing.

The actuators 16.4 and 18.4 are attached to the flange 14.4. The actuators 16.4 and 18.4 engage in the interior of the gearbox via a respective opening 32.4 and 34.4. In particular, the pinions 44.4 and 46.4 engage in the interior. The pinions 44.4 and 46.4 cooperate with a respective rack 20.4, 22.4.

The racks 20.4 and 22.4 are formed so as to be cylindrical and are guided in a respective guide 24.4, 26.4. The guides 24.4 and 26.4 take the form of guide elements, in this case in the shape of cuboids, with cylindrical openings. The racks are guided within the openings of the guide elements. Three guide elements are formed, wherein a central guide element receives both the rack 20.4 and the rack 22.4. The racks 20.4 and 22.4 are received within the same opening of the central guide element but move independently of one other.

The racks 20.4 and 22.4 each have a shift contour 70.4 and 80.4, which are provided for engaging with the shift fork or a transfer element. The shift contour is preferably connected in a form-fitting manner or connected in a force-fitting manner or attached to the shift fork or the transfer element. As shown in FIG. 11, the rack 20.4 projects axially beyond the guide element of the guide 24.4, wherein the shift fork 62.4 comprising a transfer contour 76.4 engages with the shift contour 70.4 of the rack 20.4. The shift fork 62.4 is guided via a guide rod 82.4 so that an axial movement of the rack 20.4 is converted into an axial movement of the shift fork 62.4. In contrast, the rack 22.4 does not extend axially beyond the guide elements. The shift fork 64.4 engages axially between the two guide elements of the guide 26.4 with a shift contour 80.4 of the rack 22.4. In principle, in alternative embodiment variants, it is also possible for both shift forks to engage with the shift contours of the racks in an axially intermediate or axially external position.

In this embodiment variant, the guide elements, the guide and the racks are not attached to the flange, but to the housing. In a particularly advantageous variant, the components are attached to a housing of a control device, which is itself attached to the housing of the gearbox. The gearbox actuator assembly is only fitted together during final assembly of the gearbox. In particular, during final assembly, the pinions engage with the racks, wherein the guide and rack are already installed on the gearbox in advance. In an alternative configuration, the guide and the rack are arranged on or attached to the flange. For the purposes of installation, a shift contour is provided on the rack which, during installation, engages with a transfer contour of the shift fork or a transfer element. In this alternative embodiment variant, it is possible to achieve a higher degree of pre-assembly of the gearbox actuator unit.

A gearbox actuator unit 12.5 in a further embodiment variant, which differs only slightly from the gearbox actuator unit 12.4, is shown in FIG. 13. FIG. 13 shows that one of the actuators engages with the rack from above, wherein the other actuator engages with the rack from below. A configuration of this type is optimally adapted to the installation space available.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A gearbox actuator unit which is formed so as to be arranged on a gearbox, the actuator unit comprising:
a flange, an actuator, a rack and a guide,
wherein the flange is formed so as to be connectable to a housing of the gearbox,
wherein the rack is received in an axially moveable manner within the guide, and
wherein the actuator meshes with the rack via a pinion and is formed so as to move the rack axially.

2. The gearbox actuator unit as claimed in claim 1, wherein the gearbox actuator unit is formed as a pre-assembly unit.

3. The gearbox actuator unit as claimed in claim 1, wherein the gearbox actuator unit is configured to be attached to the gearbox solely via the flange.

4. The gearbox actuator unit as claimed in claim 1, wherein the flange, actuator, rack and guide are connected solely to the flange.

5. The gearbox actuator unit as claimed in claim 1, wherein a shift is formed on, arranged on or attached to the rack.

6. The gearbox actuator unit as claimed in claim 1, wherein the shift element is formed by a shift fork, a shift claw or a shift contour.

7. The gearbox actuator unit as claimed in claim 1, wherein the actuator has a pinion which passes through an opening in the flange and extends from the flange.

8. The gearbox actuator unit as claimed in claim 1, wherein the flange has a planar and peripherally closed contact face for making contact with the housing.

9. The gearbox actuator unit as claimed in claim 1, wherein the guide is formed by the actuator, the flange or as a separate assembly.

10. A gearbox comprising a gearbox actuator unit as claimed in claim 1.
